(19) United States
(12) Patent Application Publication
(10) Pub. No.: US 2015/0059348 A1
(43) Pub. Date: Mar. 5, 2015

(54) SYSTEM AND METHOD FOR CONTROLLING FUEL DISTRIBUTIONS IN A COMBUSTOR IN A GAS TURBINE ENGINE

(71) Applicant: General Electric Company, Schenectady, NY (US)

(72) Inventors: David Kaylor Toronto, Simpsonville, SC (US); Wei Chen, Greer, SC (US)

(73) Assignee: General Electric Company, Schenectady, NY (US)

(21) Appl. No.: 14/012,976

(22) Filed: Aug. 28, 2013

(51) Int. Cl. F02C 5/12; G05D 7/06

(52) U.S. Cl. CPC F02C 5/12; G05D 7/0617
USPC 60/772; 60/39.38; 700/282

(57) ABSTRACT

The present disclosure relates to a gas turbine engine system having a plurality of combustors, wherein a first combustor includes one or more fuel nozzles and one or more fuel injectors positioned downstream from the fuel nozzles. The gas turbine engine may also include a first valve disposed along a fuel delivery line between a fuel circuit and the first combustor to adjust a first flow of the fuel to the first combustor. The gas turbine engine may also include a second valve disposed along a fuel delivery line between the first valve and at least one of the one or more fuel injectors to adjust a second flow of the fuel to at least one of the one or more fuel injectors.

### BACKGROUND

The subject matter disclosed herein relates generally to gas turbines, and, more particularly to systems and methods for operating gas turbines.

Gas turbine engines include one or more combustors, which receive and combust air and fuel to produce hot combustion gases. Some gas turbine engines produce undesirable emissions, such as oxides of nitrogen (NOx), unburned hydrocarbons (HC), and carbon monoxide (CO). In some circumstances, it may be desirable to operate the gas turbine engine at a reduced rate or power level. However, when operating at reduced rates, it is difficult to maintain low levels of emissions. For example, the temperature within the combustor may be too low to completely combust fuel when the gas turbine engine is operating at a reduced rate, and as a result, the gas turbine engine may produce undesirable emissions.

### BRIEF DESCRIPTION

Certain embodiments commensurate in scope with the originally claimed invention are summarized below. These embodiments are not intended to limit the scope of the claimed invention, but rather these embodiments are intended only to provide a brief summary of possible forms of the invention. Indeed, the invention may encompass a variety of forms that may be similar to or different from the embodiments set forth below.

In a first embodiment, a gas turbine engine system includes a plurality of combustors arranged circumferentially about a rotational axis of the gas turbine engine. A first combustor includes one or more fuel nozzles and one or more fuel injectors positioned generally downstream from the one or more fuel nozzles. The first combustor also includes a first valve disposed along a fuel delivery line between a fuel circuit and the first combustor, the first valve being configured to adjust a first flow of the fuel to the first combustor. The first combustor also includes a second valve disposed along the fuel delivery line between the first valve and at least one of the one or more fuel injectors, the second valve being configured to adjust a second flow of the fuel to at least one of the one or more fuel injectors.

In a second embodiment, a method of operating a gas turbine engine is provided. The method includes the steps of directing fuel to a plurality of combustors using a controller, wherein each of the plurality of combustors is configured to receive fuel via one or more fuel nozzles and one or more fuel injectors, wherein the one or more fuel nozzles are positioned proximate to a first end of each of the plurality of combustors and the one or more fuel injectors are positioned proximate to a second end of each of the plurality of combustors. The method may also include stopping a first flow of fuel to a subset of the plurality of combustors using the controller, and adjusting a second flow of fuel to the one or more fuel injectors of at least one of the plurality of combustors that is not in the subset using a controller.

In a third embodiment, a system includes instructions disposed on a non-transitory, machine readable medium, and the instructions are configured to direct fuel to a plurality of combustors, wherein each combustor is coupled to a plurality of fuel nozzles positioned proximate to a first end of the combustor and at least one fuel injector positioned proximate to a second end of the combustor. The system also includes instructions to control a first valve to stop a first flow of fuel to a subset of the plurality of combustors, and to control a second valve to adjust the second flow of fuel to the at least one fuel injector of at least one of the plurality of combustors that is not part of the subset.

### BRIEF DESCRIPTION OF THE DRAWINGS

These and other features, aspects, and advantages of the present invention will become better understood when the following detailed description is read with reference to the accompanying drawings in which like characters represent like parts throughout the drawings, wherein:

FIG. 1 is a block diagram of an embodiment of a gas turbine system;

FIG. 2 is a partial side cross-sectional view of an embodiment of a gas turbine system;

FIG. 3 is a schematic illustration of an embodiment of a gas turbine system having a plurality of control devices to adjust the flow of fuel within the gas turbine system;

FIG. 4 is a schematic illustration of an embodiment of a gas turbine system having a plurality of control devices to adjust the flow of fuel within a plurality of combustors;

FIG. 5 is a schematic illustration of an embodiment of a gas turbine system having a plurality of control devices to adjust the flow fuel within a plurality of combustors;

FIG. 6 is a schematic illustration of an embodiment of a gas turbine system having a plurality of combustors arranged into a plurality of sectors, and a plurality of control devices to adjust the flow of fuel within the plurality of combustors; and

FIG. 7 is a front perspective view of an arrangement of combustors within a gas turbine system, in accordance with one embodiment.

### DETAILED DESCRIPTION

One or more specific embodiments of the present invention will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present invention, the articles “a,” “an,” “the,” and “said” are intended to mean that there are one or more of the elements. The terms “comprising,” “including,” and “having” are intended to be inclusive and mean that there may be additional elements other than the listed elements.

Gas turbine systems in accordance with the present disclosure may be configured to operate at reduced rates or power levels (e.g., turn down), while maintaining suitably low emissions. The primary emissions typically produced by gas turbine engines of gas turbine systems include oxides of nitrogen (NOx), unburned hydrocarbons (HC), and carbon monoxide (CO), which are subject to various federal and state regulatory limitations. Emissions may be reduced and/or maintained within regulatory compliance by certain operational conditions within the gas turbine system. For example, NOx and CO emissions may be kept within compliance if flame temperatures within a combustor of the gas turbine system are maintained at certain levels. The flame temperature within the combustor is highly dependent upon the fuel/air ratio, and thus, the temperature and emissions may be controlled by adjusting the fuel flow within the combustor. In some circumstances, however, it may be desirable to operate the gas turbine system at a reduced rate or power level. For example, during off-peak hours it is impractical and expensive to operate the gas turbine system at full power. Additionally, completely stopping and restarting the gas turbine system is a lengthy process and can impact the durability of system components. Thus, it is generally preferred to turn down the gas turbine system, rather than stopping the gas turbine engine, during periods of low demand. The reduced power level may be achieved by decreasing the fuel flow to the combustor. However, when operating at such reduced power levels, it can be particularly difficult to maintain emissions compliance. For example, the temperatures within the combustor may be too low to complete combustion of the fuel, which may result in an increase in emissions.

Certain turn down methods that enable the gas turbine system to remain emissions compliant may generally result in a decrease in power level to only about 40% of normal output. The present disclosure provides systems and methods to enable the gas turbine system to operate at very low power levels, while maintaining suitably low emissions. For example, systems and methods in accordance with the present disclosure may enable the gas turbine system to remain emission compliant and turn down to about 15%, 20%, 25%, or 30% of normal output. By providing one or more control devices (e.g., valves), the flow of fuel may be directed and adjusted in a manner that enables the gas turbine system to achieve very low power levels and low emissions. For example, valves may be controlled to adjust the flow of fuel to certain fuel injectors and/or to certain combustors within the gas turbine system in a manner that results in reduced rates and fuel/air ratios that maintain low emissions. More particularly, in some turn down operations discussed herein, the flow of fuel to certain downstream fuel injectors (e.g., late lean injectors) may be reduced and the flow of fuel to at least one of the combustors in the gas turbine system may be reduced or stopped. Such turn down methods may also enable the gas turbine system to quickly return to full power if demand increases. Additionally, in some embodiments of the present disclosure, the flow of fuel may be adjusted to shut down the combustor in a manner that reduces thermal stress on the components along the hot gas path, as described in more detail below.

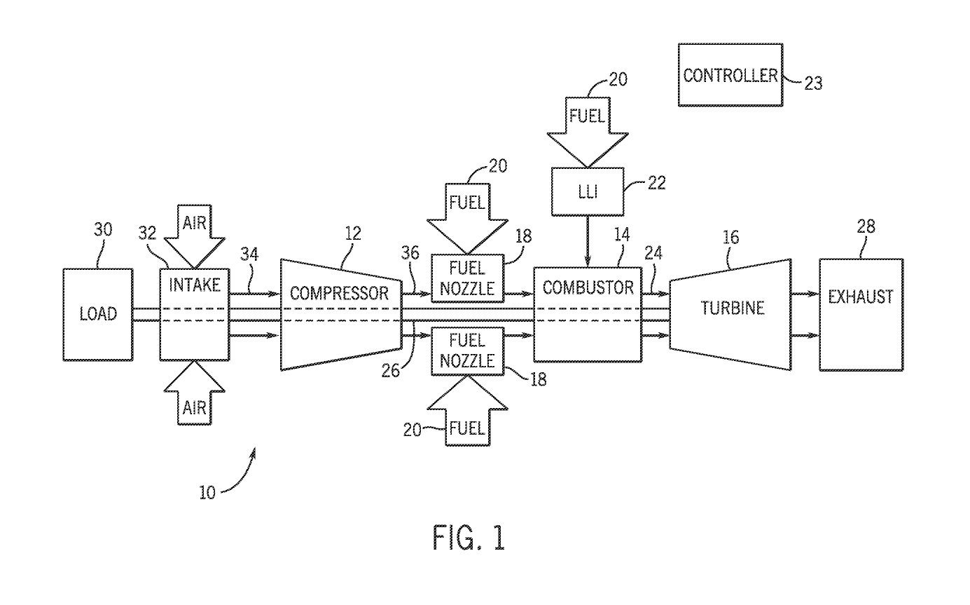

Turning to the drawings, FIG. 1 illustrates a block diagram of an embodiment of a gas turbine system 10, which may be configured to operate at low power levels while maintaining suitably low emissions. The systems and methods described herein may be used in any turbine system, such as gas turbine systems, and is not intended to be limited to any particular machine or system. As shown, the system 10 includes a compressor 12, a turbine combustor 14, and a turbine 16. The system 10 may include one or more combustors 14 that include one or more fuel nozzles 18 configured to receive a liquid fuel and/or gas fuel 20, such as natural gas or syngas. The system 10 may also include one or more fuel injectors 22 (e.g., late lean fuel injectors or LLI's) positioned generally downstream from the one or more fuel nozzles 18 and configured to inject the fuel 20, or a mixture of fuel 20 and air, into the combustor 14. The system 10 may include a controller 23 that is generally configured to control the flow of fuel to the one or more fuel nozzles 18 and/or to the one or more LLI's 22. The controller 23 may be any suitable engine controller that is configured to send and/or to receive signals from the gas turbine system 10 and to control the flow of fuel within the gas turbine system 10.

The turbine combustors 14 ignite and combust a fuel-air mixture, and then pass hot pressurized combustion gases 24 (e.g., exhaust) into the turbine 16. Turbine blades are coupled to a shaft 26, which is also coupled to several other components throughout the turbine system 10. As the combustion gases 24 pass through the turbine blades in the turbine 16, the turbine 16 is driven into rotation, which causes the shaft 26 to rotate. Eventually, the combustion gases 24 exit the turbine system 10 via an exhaust outlet 28. Further, the shaft 26 may be coupled to a load 30, which is powered via rotation of the shaft 26. For example, the load 30 may be any suitable device that may generate power via the rotational output of the turbine system 10, such as an electrical generator, a propeller of an airplane, and so forth.

Compressor blades may be included as components of the compressor 12. The blades within the compressor 12 are coupled to the shaft 26, and will rotate as the shaft 26 is driven to rotate by the turbine 16, as described above. An intake 32 feeds air 34 into the compressor 12, and the rotation of the blades within the compressor 12 compress the air 34 to generate pressurized air 36. The pressurized air 36 is then fed into the one or more fuel nozzles 18 and/or the LLI's 22 of the turbine combustors 14. The one or more fuel nozzles 18 mix the pressurized air 36 and fuel 20 to produce a suitable mixture ratio for combustion (e.g., a combustion that causes the fuel to more completely burn) so as not to waste fuel or cause excess emissions. As described in more detail below, the system 10 may be configured to operate at very low power levels while maintaining suitably low emissions.

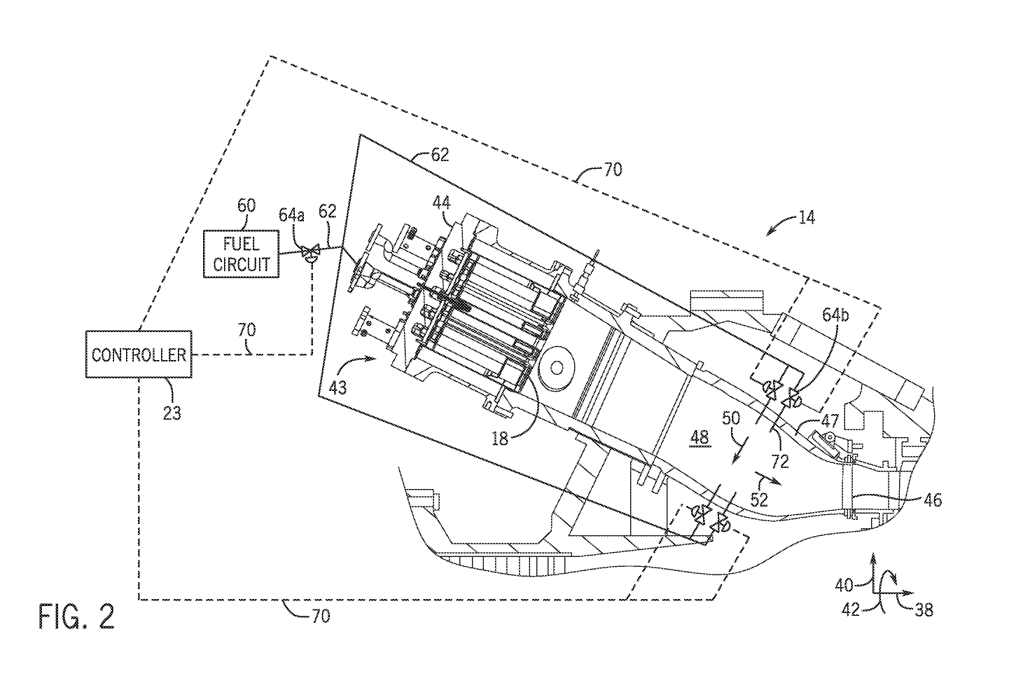

FIG. 2 is a partial cross-sectional side view of an embodiment of the combustor 14 of the gas turbine system 10. As shown, the gas turbine system 10 may be described with reference to a longitudinal axis or direction 38, a radial axis or direction 40, and a circumferential axis or direction 42. The gas turbine system 10 includes one or more fuel nozzles 18 disposed within a head end 43 of the combustor 14. The one or more fuel nozzles 18 may also be generally positioned proximate to (e.g., near, adjacent, etc.) a first end 44 of the combustor 14. Further, the combustor 14 may include one or more late lean injectors 22 (LLI's) positioned proximate to a second end 46 of the combustor, the second end 46 being located generally downstream from the first end 44 in a direction of flow of hot combustion gases toward the turbine 16.

As shown in FIG. 2, one or more control devices, or valves 64, may be provided to control the flow of fuel 20. The valves 64 may be arranged in any suitable manner. For example, in the depicted embodiment, at least one valve 64a is disposed along a fuel delivery line 62 (e.g., manifold) between a fuel circuit 60 and the combustor 14, and the valve 64a is positioned so that the valve 64a may adjust delivery of fuel 20 to the combustor 14 (e.g., to the one or more fuel nozzles 18 and to the LLI's 22).

Additionally, one or more valves 64b may be provided to enable an additional level of control or independent control of the flow of fuel 20 to the LLI's 22. In the illustrated embodiment, the valves 64b are disposed along the fuel delivery line 62 between the valve 64a and the LLI's 22. As shown, the LLI's 22 may be structurally supported by a liner and/or flow sleeve 47 surrounding a transition zone 48 of the combustor 14. The LLI's 22 are configured to provide fuel 20 to the combustor 14 at one or more axial stages, or regions, along the longitudinal axis 38 of the combustor 14. The LLI's 22 may be configured to inject fuel 20 into the combustor 14 as shown by arrows 50, the fuel 20 being injected in a direction that is generally transverse to a flow direction 52 within the combustor 14. Such a configuration creates local zones of stable combustion within the combustor 14 during operation of the gas turbine system 10. Additionally, the flow of fuel 20 to the LLI's 22 may also be adjusted by valves 64a, 64b in a manner that facilitates turn down while maintaining suitably low emissions, as described in more detail below.

As discussed above, the one or more LLI's 22 may be disposed at one or more axial stages or regions of the combustor 14. In some embodiments, multiple LLI's 22 are disposed circumferentially 42 about the combustor 14 at a single axial stage along the longitudinal axis 38 of the combustor 14. In certain embodiments, multiple LLI's 22 are disposed circumferentially 42 about the combustor 14 at multiple axial stages along the longitudinal axis 38 of the combustor 14. Thus, a first axial stage may include one or more LLI's 22, and a second axial stage may include one or more LLI's 22. The LLI's 22 may be arranged in any suitable manner. For example, the LLI's 22 of the first axial stage and the LLI's 22 of the second axial stage may be circumferentially 42 staggered with respect to one another. The axial stages may also include the same number or a different number of LLI's 22.

The fuel circuit 60 may supply the fuel 20 to the fuel nozzles 18 and/or to the LLI's 22. The fuel 20 may be delivered to the fuel nozzles 18 and/or to the LLI's 22 via the fuel delivery line 62. It should be understood that multiple fuel circuits and/or multiple fuel delivery lines 62 may be incorporated into the systems of the present disclosure. As indicated above, one or more valves 64b may be provided to independently adjust the flow of fuel 20 to the LLI's 22. In the embodiment of FIG. 2, one valve 64b is provided for each LLI 22, although any suitable configuration is envisioned. In some embodiments, one valve 64b may adjust the flow of fuel 20 to more than one LLI 22. In some embodiments, one valve 64b may adjust the flow of fuel 20 to all of the LLI's 22 circumferentially 40 arranged in a single axial stage. Thus, the LLI's 22 of one axial stage may be operated together. In some embodiments, one valve 64b may adjust the flow of fuel 20 to each of the LLI's 22 of two or more axial stages. Thus, the LLI's 22 of multiple axial stages may be operated together. In some embodiments, one valve 64b may adjust the flow of fuel 20 to all of the LLI's 22 of the combustor 14 or to the LLI's 22 of multiple combustors 14 of the gas turbine system 10.

The controller 23 may be in communication with the one or more valves 64. The controller 23 is configured to provide a signal 70 to the valves 64 to open, close, or modulate the valves 64. Thus, in the illustrated embodiment, the controller 23 controls the valves 64 to adjust the flow and delivery of fuel 20 to the entire combustor 14 and/or to separately control the flow of fuel 20 to the LLI's 22. The various valves 64 of the combustor 14 may be positioned in any suitable arrangement and may be adjusted in any suitable manner to enable low turn down, as described in more detail below.

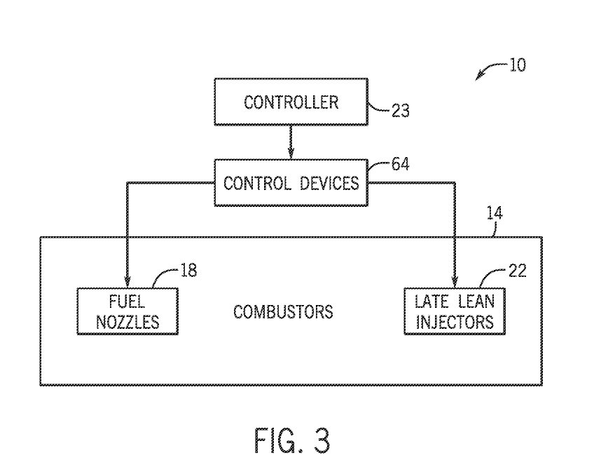

FIG. 3 is a schematic illustration of an embodiment of the gas turbine system 10. As shown, the controller 23 is configured to control one or more control devices, or valves 64. The one or more valves 64, in turn, affect or adjust the flow of fuel 20 to various components (e.g., fuel nozzles 18 and LLI's 22) of the combustors 14 of the gas turbine system 10. For example, in certain turn down operations, the one or more valves 64 may first reduce the flow of fuel 20 to the LLI's 22 of one or more combustors 14. When a certain threshold fuel flow rate or temperature is achieved in one or more of the combustors 14 (e.g., as monitored by a sensor or other monitoring device integrated into the system 10), the one or more valves 64 may subsequently stop the flow of fuel 20 to at least one of the combustors 14 of the gas turbine system 10. As described in more detail below, these components of the gas turbine system 10 may be arranged in various configurations and may be operated via various methods to enable very low turn down while maintaining suitably low emissions.

The controller 23 may independently control operation of the gas turbine system 10 by electrically communicating with the one or more valves 64 and/or other flow adjusting features of the gas turbine system 10. The controller 23 may also electrically communicate with one or more sensors, as described in more detail below. The controller 23 may include a distributed control system (DCS) or any computer-based workstation that is fully or partially automated. For example, the controller 23 may be any device employing a general purpose or an application-specific processor, both of which may generally include memory circuitry for storing instructions related to combustion parameters, such as flame temperatures and fuel flow rates. The processor may include one or more processing devices, and the memory circuitry may include one or more tangible, non-transitory, machine-readable media collectively storing instructions executable by the processor to perform the methods and control actions described herein. Such machine-readable media can be any available media that can be accessed by the processor or by any general purpose or special purpose computer or other machine with a processor. By way of example, such machine-readable media can comprise RAM, ROM, EPROM, EEPROM, CD-ROM or other optical disk storage, magnetic disk storage or other magnetic storage devices, or any other medium which can be used to carry or store desired program code in the form of machine-executable instructions or data structures and which can be accessed by the processor or by any general purpose or special purpose computer or other machine with a processor. When information is transferred or provided over a network or another communications connection (either hardwired, wireless, or a combination of hardwired or wireless) to a machine, the machine properly views the connection as a machine-readable medium. Thus, any such connection is properly termed a machine-readable medium. Combinations of the above are also included within the scope of machine-readable media. Machine-executable instructions comprise, for example, instructions and data which cause the processor or any general purpose computer, special purpose computer, or special purpose processing machines to perform a certain function or group of functions. As discussed below, the controller 23 may use information provided via input signals received from one or more sensors to execute instructions or code contained on the machine-readable or computer-readable storage medium and generate one or more output signals 70 to the various valves 64. For example, based on the execution of the instructions or code contained on the machine-readable or computer-readable storage medium of the controller 23, the output signals 70 may be used to control the flow of fuel 20 within the gas turbine system 10.

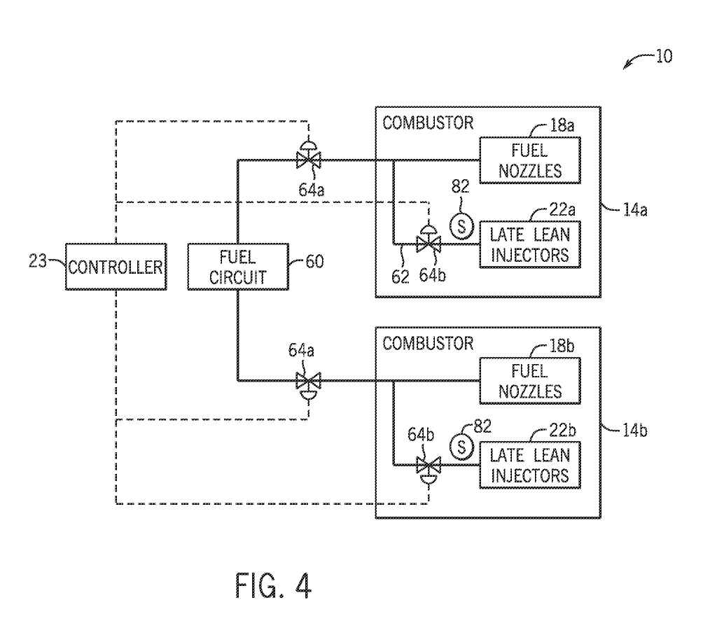

FIG. 4 is a schematic illustration of an embodiment of the gas turbine system 10 having a plurality of valves 64 configured to adjust the flow of fuel 20 within the plurality of combustors 14. In the depicted embodiment, a first combustor 14a (e.g., a first combustor can) includes one or more fuel nozzles 18a, which may be disposed within the head end 43 and positioned proximate to the first end 44 of the combustor 14a. Additionally, the first combustor 14a includes one or more LLI's 22a positioned proximate to the second end 46 of the combustor 14a. The gas turbine system 10 may include the controller 23, which is configured to control the plurality of valves 64. As shown, a first valve 64a may be disposed along the fuel delivery line 62 between the fuel circuit 60 and the first combustor 14a. The first valve 64a may be configured to adjust the flow of fuel 20 to the first combustor 14a. Additionally, a second valve 64b may be disposed along the fuel delivery line 62 between the first valve 64a and the LLI's 22. The second valve 64b may be configured to provide an additional level of control and to independently adjust the flow of fuel 20 to the LLI's 22a of the first combustor 14a. As discussed above with respect to FIG. 2, one valve 64b may be provided for each LLI 22 or for the LLI's 22 at each axial stage or for all of the LLI's of the first combustor 14a, for example. As shown, a second combustor 14b (e.g., a second combustor can) may have a similar arrangement of fuel nozzles 18b, LLI's 22b, and valves 64 as the first combustor 14a, although it should be understood that the various combustors 14 of the system 10 may have different arrangements and configurations.

As discussed above, the controller 23 may control the valves 64 to adjust the amount of fuel 20 that is delivered from the fuel circuit 60 to various components (e.g., the fuel nozzles 18 and/or the LLI's 22) of the combustors 14. In some embodiments, the controller 23 may selectively operate the valves 64 based upon sensed combustion parameters in the combustors 14. For example, in certain embodiments, one or more sensors 82 may be configured to sense flow rates of fuel 20 within the fuel delivery lines 62. The information obtained by the one or more sensors 82 may be provided to the controller 23, and the controller 23 may initiate various actions, such as opening or closing certain valves 64. As described in more detail below, the controller 23 may partially close or shut (e.g., completely close) one or more of the valves 64 in one or more of the combustors 14 of the gas turbine system 10 in a manner that reduces fuel consumption and maintains emissions compliance.

With reference to FIG. 4, during a turn down operation, the controller 23 may control the valves 64 to reduce the flow of fuel 20 to certain portions of the gas turbine system 10. In some embodiments, the controller 23 may control one or more valves 64b to reduce the flow of fuel 20 to one or more LLI's 22 of one or more of the combustors 14. The flow of fuel 20 to the LLI's 22 may be reduced to a certain flow rate (e.g., a threshold rate) or the flow of fuel to the LLI's 22 may be reduced until a certain flame temperature (e.g., a threshold flame temperature) is achieved within the combustor 14, for example. As discussed above, in some embodiments, one or more sensors 82 may be provided to detect fuel flow rates and/or temperatures within the combustor 14. The information collected by the one or more sensors 82 may be used to determine or trigger subsequent steps in the turn down process. For example, when the flow of fuel 20 to the LLI's 22 of one or more of the combustors 14 reaches a certain threshold flow rate (e.g., a lower threshold flow rate) via valves 64b, then the controller 23 may subsequently control the valves 64a to reduce or to stop the flow of fuel 20 to at least one of the combustors 14 of the gas turbine system 10. Additionally, in some embodiments, emissions of the system 10 may be monitored by the sensor 82 or other suitable monitoring device. Thus, the controller 23 may be configured to dynamically adjust the flow of fuel to the LLI's 22 and/or to the fuel nozzles 18, and/or to stop the flow of fuel to at least one of the combustors 14 to maintain emissions compliance (e.g., below an emissions threshold) during the turn down process.

In the embodiment of FIG. 4, the flow of fuel 20 to the LLI's 22 of one or more of the combustors 14 may be reduced to zero (or nearly zero), and subsequently the valve 64a of the first combustor 14a may be controlled. In certain embodiments, the controller 23 may control the valve 64a of the first combustor 14a to reduce or stop the flow of fuel 20 to at least the first combustor 14 of the gas turbine system 10. As a result, the fuel 20 may be directed to adjacent combustors 14, such as the second combustor 14b, which may increase the fuel/air ratio in the second combustor 14b. Such methods may reduce operating power by effectively shutting down the first combustor 14a and forcing fuel 20 to the second combustor 14b, so that the second combustor 14b has a higher flame temperature and achieves low emissions. Although only two combustors 14 are shown in FIG. 2, it should be understood that in certain embodiments, the controller 23 may control one or more valves 64a to stop the flow of fuel 20 to one quarter, one half, or any suitable fraction of the combustors 14 of the gas turbine system 10.

Additionally, the gas turbine system 10 may be returned to full power by controlling valves 64a to increase the flow of fuel 20 to at least the turned down combustors 14 of the system 10. The valves 64b may additionally be controlled to adjust the flow of fuel 20 to the LLI's 22, thus increasing the power levels of the gas turbine system 10. Because the gas turbine system 10 can be operated at very low turn down rates via the current methods, the gas turbine engine may not need to be fully shut down during periods of low demand or during off-peak hours. Thus, the gas turbine system 10 does not go through a lengthy start-up process to increase the power level.

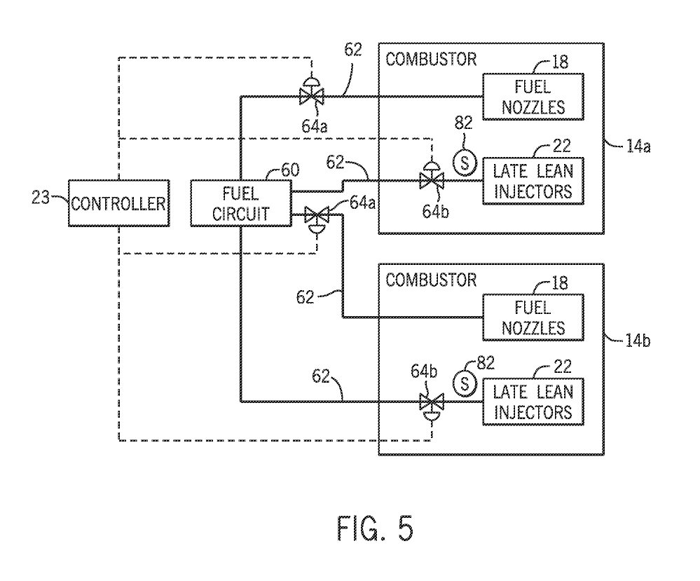

FIG. 5 is a schematic illustration of another embodiment of a gas turbine system 10 having a plurality of combustors 14 and a plurality of valves 64 configured to adjust the flow of fuel 20 within the plurality of combustors 14. In the depicted embodiment, the first valve 64a is positioned such that the flow of fuel 20 to the fuel nozzles 18 maybe adjusted without affecting the flow of fuel 20 to the LLI's 22. Thus, the first valve 64a may be provided to independently control the flow of fuel 20 to the fuel nozzles 18, while the second valve 64b may be provided to independently control the flow of fuel 20 to the LLI's 22. In certain embodiments, such control may be achieved by positioning the first valve 64a along the fuel delivery line 62 between the fuel circuit 60 and the fuel nozzles 18 and by positioning the second valve 64b along the fuel delivery line 62 between the fuel circuit 60 and the LLI's 22. With reference to FIG. 5, in a turn down operation, the flow of fuel 20 to the LLI's 22 of the first combustor 14a may be adjusted via the second valve 64b. When a certain threshold is reached (e.g., flow rate, flame temperature, etc.), the flow of fuel to the fuel nozzles 18 may be separately adjusted by the first valve 64a. However, in the illustrated embodiment, the first valve 64a does not affect the flow of fuel 20 to the LLI's 22. Thus, the depicted system 10 provides additional operational flexibility. For example, the first valve 64a and the second valve 64b may be operated simultaneously or the flow of fuel 20 to the fuel nozzles 18 and the LLI's 22 may be fine tuned based system conditions. Additionally, such a configuration may be utilized to efficiently turn down and to fully shut down the gas turbine system 10. In certain embodiments, the first valve 64a may be controlled to adjust the flow of fuel 20 to the one or more fuel nozzles 18, without affecting the flow of fuel 20 to the LLI's 22. Once the flow of fuel 20 to the one or more fuel nozzles 18 reaches a certain threshold (e.g., flow rate, flame temperature, etc.), the second valve 64b may be subsequently controlled to reduce the flow of fuel 20 to the LLI's 22. Such a technique may be utilized to stop the flow of fuel 20 to one or more combustors 14 within the gas turbine system 10. Furthermore, such a technique may allow for improved shutdown procedures for the gas turbine system 10, as the thermal stress to components along the hot gas path may be reduced.

Additionally, although not shown in FIG. 5, in certain embodiments, an additional valve 64 may be provided upstream of the first valve 64a to adjust the flow of fuel 20 to at least one combustor 14 (e.g., to both the fuel nozzles 18 and to the LLI's 22 of the combustor 14), as in FIG. 4. Such a configuration would provide additional operational flexibility and control to adjust the flow of fuel 20 within the gas turbine system 10. The gas turbine system 10 illustrated in FIG. 5 would also enable relatively quick increase in power when demand increases. The valves 64 may adjust the flow of fuel 20 to the fuel nozzles 18 and/or to the LLI's 22 to increase the power, without having to go through a lengthy start-up process.

Although a single fuel circuit 60 is shown in FIG. 5, it should be understood that multiple fuel circuits 60 may be provided. In some embodiments, the fuel 20 may be delivered from the fuel circuit 60 to the one or more fuel nozzles 18 located at the first end 44 of the combustor, and additional fuel 20 or a second different fuel (e.g., LLI fuel) may be delivered from a second different fuel circuit to one or more of the LLI's 22. The LLI fuel may include any suitable fuel composition or alternate gas, such as refinery gases or gases having a reactivity higher than methane, for example. Such an arrangement may provide for increased flexibility in the types of fuel that can be utilized and may provide for additional flexibility in the ways in which the flow of fuel 20 can be controlled to enable the system 10 to run at reduced rates and maintain low emissions. The arrangement of the valves 64, fuel nozzles 18, and the LLI's 22 shown in FIG. 5 would enable independent control of the different types of fuels to the fuel nozzles 18 and/or to the LLI's 22 within the combustor 14.

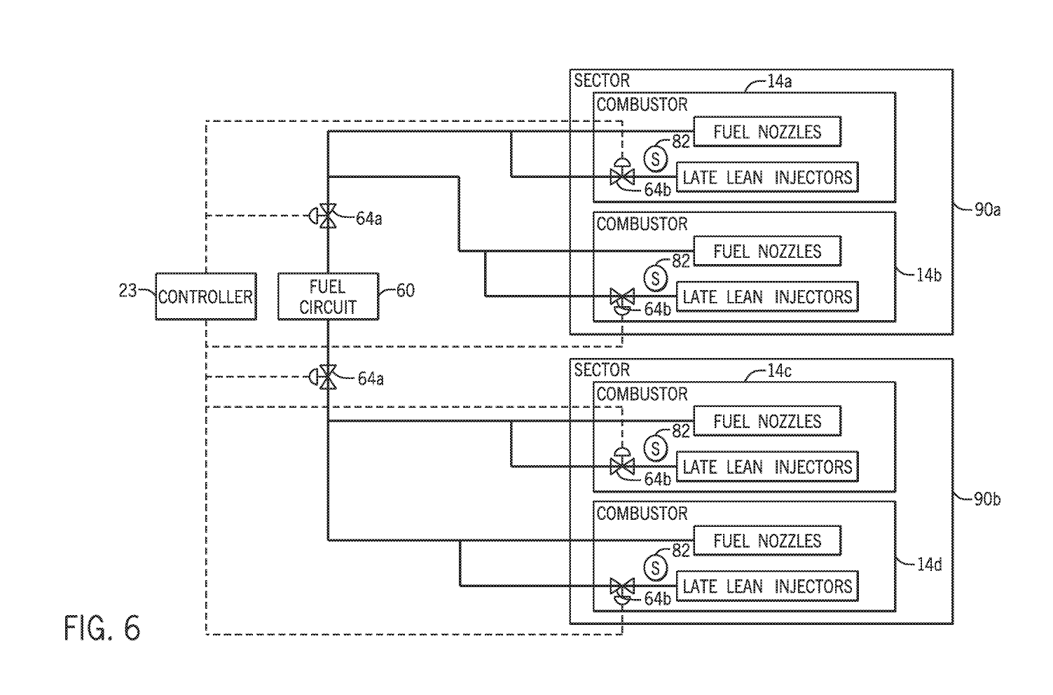

FIG. 6 is a schematic illustration of an embodiment of a gas turbine system 10 having a plurality of valves 64 to adjust the flow of fuel 20 within the plurality of combustors 14. In the depicted embodiment, the plurality of combustors 14 are arranged into sectors 90 (e.g., subsets of combustors 14). For example, a first combustor 14a and a second combustor 14b are arranged into a first sector 90a, and a third combustor 14c and a fourth combustor 14d are arranged into a second sector 90b. It should be understood that any suitable number of sectors 90 may be provided (e.g., 2, 3, 4, 5, 6, 7, 8, 9, 10, or more), and that each sector 90 may include any suitable number of combustors 14 (e.g., 2, 3, 4, 5, 6, 7, 8, 9, 10, or more). The sectors 90 may include adjacent combustors 14 or non-adjacent (e.g., alternating) combustors 14. In some embodiments, the flow of fuel 20 to each sector 90 may be controlled by the first valve 64a. With reference to FIG. 6, in a turn down operation, the flow of fuel 20 to the LLI's 22 of one or more of the combustors 14 may be reduced to a certain threshold via one or more second valves 64b. As shown, one second valve 64b may be provided for each combustor 14, although as discussed above, one second valve 64b may be provided for each LLI 22, for the LLI's 22 of each sector 90, or for the LLI's 22 for the entire gas turbine system 10, for example. Once the threshold is reached via the valves 64b, one or more of the first valves 64a may be controlled to adjust the flow of fuel 20 to one or more of the sectors 90. In some embodiments, one or more of the first valves 64a may be controlled so that fuel 20 is only supplied to some of the sectors 90. For example, one or more of the first valves 64a may be controlled so that fuel 20 is supplied to only one half of the sectors 90 and/or one half of the combustors 14. As will be understood by one of skill in the art, the various combustors 14 and the various sectors 90 within the system 10 may have different arrangements and configurations. For example, any of the previous configurations illustrated in FIGS. 4 and 5 may be used for each of the sectors 90, and the sectors 90 of the gas turbine system 10 may have configurations different from one another.

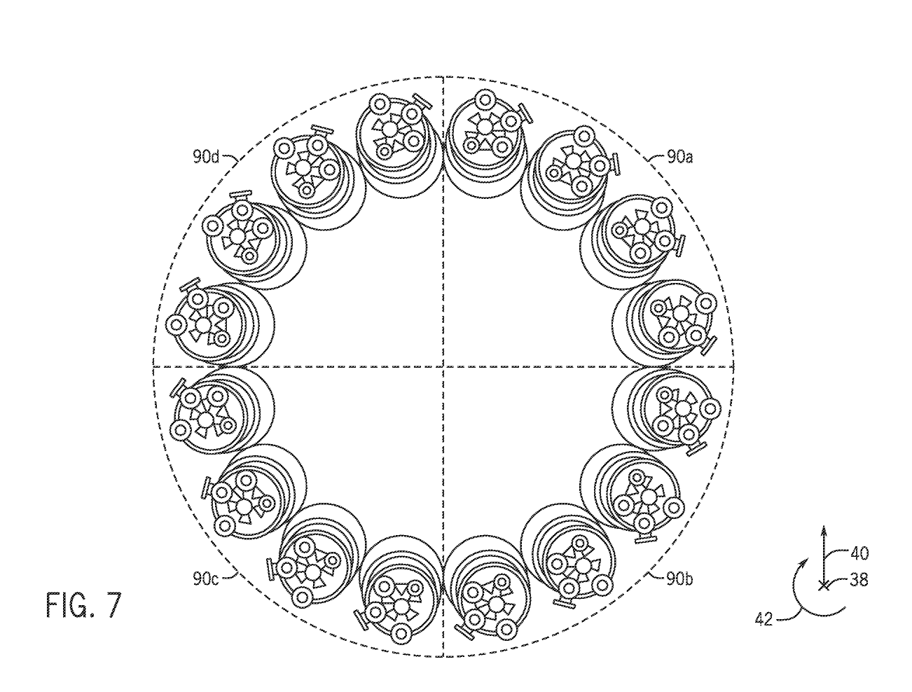

FIG. 7 is a front perspective view of the gas turbine system 10 having a plurality of combustors 14 (e.g., 14 combustors) arranged circumferentially 42 about the longitudinal axis 38 of the gas turbine system 10. The combustors 14 may be arranged into any suitable number of sectors 90, and each sector 90 may include any number of combustors 14. For example, as shown, the combustors 14 are arranged into four sectors 90a, 90b, 90c, 90d, each sector 90 having four combustors 14. As discussed above, each sector 90 may include a series of adjacent combustors 14, or the sectors 90 may include non-adjacent combustors 14 (e.g., alternating combustors 14, or every third, fourth, or fifth combustor 14, etc.). The flow of fuel 20 may be controlled to certain combustors 14 and/or certain sectors 90. For example, the flow of fuel 20 to one sector 90 or to any subset of combustors 14 may be reduced or stopped by adjusting one or more valves 64. In some embodiments, the flow of fuel 20 to the combustors 14 of each sector 90 may be controlled by one valve 64. For example, one valve 64 may adjust the flow of fuel 20 to all of the combustors 14 within one sector 90. Such a configuration may enable efficient turn down with less hardware (e.g., fewer valves), and reduce the processing steps, for example.

The embodiments described above provide examples of techniques for operating the gas turbine system 10 at a reduced rate or power level while maintaining emissions compliance. It should be understood that the controller 23 may be configured to gradually turn down or change the flow of fuel to the various parts of the gas turbine system 10 in any suitable order or sequence. Thus, the controller 23 may control the turn down process by sequentially or gradually reducing the flow of fuel to one or more of the LLI's 22, reducing the flow of fuel to one or more of the fuel nozzles 18, and/or turning off (e.g., stop) the flow of fuel to one or more combustors 14 or sectors 90 of combustors 14 in any sequence or order. For example, the controller 23 may first reduce the flow of fuel to one or more LLI's 22 and then stop the flow of fuel to a subset of the combustors 14 (e.g., one or more, but not all). In some embodiments, the controller 23 may first stop the flow of fuel to the subset of the combustors 14 (e.g., one or more, but not all) and then reduce the flow of fuel to one or more LLI's 22 that are coupled to other combustors 14 (e.g., active combustors, combustors that are not part of the subset) of the gas turbine system 19. Additionally, in some embodiments, certain steps of the turn down process may be carried out simultaneously. For example, the flow of fuel to some or all of the LLI's 22 may be reduced as the flow of fuel to the subset of the combustors 14 is reduced. Furthermore, as noted above, the gas turbine system may include sensors 82 or other monitoring and processing devices that are configured to monitor various features of the gas turbine system 10, including flow rates, temperature within one or more of the combustors 14, and/or emissions produced by the gas turbine system 10. Thus, the gas turbine system may be configured to progressively and dynamically change the fuel flow to the LLI's 22 and the fuel nozzles 18 and/or to stop the flow of fuel to the subset of combustors 14 in response to monitored temperature and/or emissions levels, thus facilitating turn down while maintaining emissions compliance (e.g., a temperature or emissions threshold). For example, the controller 23 may increase the flow of fuel to one or more LLI's 22 if the monitored temperature and/or emissions level exceeds a pre-programmed threshold.

As indicated above, in some circumstances, it may be desirable to operate the gas turbine system 10 at a reduced rate or power level. For example, during off-peak hours, it may be impractical and expensive to operate the gas turbine system 10 at full power. Additionally, completely stopping and restarting the gas turbine system 10 is a lengthy process and can impact the durability of system components. However, when operating at such reduced power levels, it can be particularly difficult to maintain emissions compliance. Thus, the present disclosure provides systems and methods to enable the gas turbine system 10 to operate at very low power levels, while maintaining suitably low emissions. For example, systems and methods in accordance with the present disclosure may enable the gas turbine system to remain emission compliant and turn down to about 15% of normal output (e.g., 15, 20, 25, 30, 35, 40, 45, 50, 55, 60, 65, 70, 75, 80, 85, or 90%, or any ranges therebetween). By providing one or more control devices (e.g., valves), the flow of fuel may be directed and adjusted in a manner that enables the gas turbine system 10 to achieve very low power levels and low emissions. For example, valves may be controlled to adjust the flow of fuel to certain fuel injectors and/or to certain combustors within the gas turbine system 10 in a manner that results in reduced rates and fuel/air ratios that maintain low emissions. The above embodiments are provided as examples and are not intended to be limiting. Thus, any suitable number and arrangement of valves to adjust the flow of fuel to the various components (e.g., the fuel nozzles and/or the LLI's) may be utilized in accordance with the present disclosure. Such turn down methods may also enable the gas turbine system 10 to quickly return to full power if demand increases. Additionally, in some embodiments, the flow of fuel may be adjusted to shut down the combustor in a manner that reduces thermal stress on the components along the hot gas path. Technical effects of the presently disclosed embodiments include the ability for the gas turbine system 10 to operate at a low power level, while maintaining emissions compliance.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

1. A gas turbine engine system, comprising:
a plurality of combustors arranged circumferentially about a rotational axis of the gas turbine engine, a first combustor of the plurality of combustors comprising:
one or more fuel nozzles;
one or more fuel injectors positioned generally downstream from the one or more fuel nozzles;
a first valve disposed along a fuel delivery line between a fuel circuit and the first combustor, the first valve configured to adjust a first flow of the fuel to the first combustor; and
a second valve disposed along the fuel delivery line between the first valve and at least one of the one or more fuel injectors, the second valve configured to adjust a second flow of the fuel to at least one of the one or more fuel injectors.

2. The gas turbine engine system of claim 1, comprising a second combustor of the plurality of combustors, wherein the first valve is configured to adjust a third flow of fuel to the second combustor.

3. The gas turbine engine system of claim 1, comprising a controller configured to control the first and the second valves.

4. The gas turbine engine system of claim 1, wherein the plurality of combustors are arranged in a plurality of sectors, and wherein the first valve is configured to adjust a third flow of fuel to a first sector of the plurality of sectors.

5. The gas turbine engine system of claim 1, wherein the second valve is configured to reduce the second flow of fuel to the one or more fuel injectors before the first valve reduces the first flow of fuel to the combustor.

6. The gas turbine engine system of claim 1, comprising a sensor configured to detect a characteristic of a combustion process.

7. The gas turbine engine system of claim 6, wherein a controller is configured to close the first valve when the sensor detects that a flow rate of the second fuel to the one or more fuel injectors reaches a threshold flow rate.

8. The gas turbine engine system of claim 6, wherein the sensor is configured to monitor emissions produced by the gas turbine system, and wherein the gas turbine system is configured to adjust the first flow of fuel or the second flow of fuel to maintain the emissions produced below a threshold.

9. The gas turbine engine system of claim 1, comprising a third valve configured to adjust a third flow of fuel to the one or more fuel nozzles without affecting the second flow of fuel to the one or more fuel injectors.

10. The gas turbine engine system of claim 9, wherein the second valve is configured to reduce the second flow of fuel to the one or more fuel injectors before the third valve reduces the third flow of fuel to the one or more fuel nozzles.

11. A method of operating a gas turbine engine, comprising:
directing fuel to a plurality of combustors using a controller, wherein each combustor of the plurality of combustors receives fuel via one or more fuel nozzles and one or more fuel injectors, wherein the one or more fuel nozzles are positioned proximate to a first end of each of the plurality of combustors and the one or more fuel injectors are positioned proximate to a second end of each of the plurality of combustors;
stopping a first flow of fuel to a subset of the plurality of combustors using the controller; and
adjusting a second flow of fuel to the one or more fuel injectors of at least one of the plurality of combustors that is not in the subset using the controller.

12. The method of claim 11, comprising closing a first valve to stop the first flow of fuel to the subset of the plurality of combustors before controlling a second valve to reduce the second flow of fuel to the one or more fuel injectors of at least one of the plurality of combustors that is not in the subset using the controller.

13. The method of claim 12, comprising adjusting the second flow of fuel to the one or more fuel injectors of at least one of the plurality of combustors that is in the subset before stopping the first flow of fuel to the subset using the controller.

14. The method of claim 11, comprising monitoring emissions produced by the gas turbine engine and adjusting the first flow of fuel or the second flow of fuel to maintain the emissions produced below a threshold.

15. A system, comprising:
instructions disposed on a non-transitory, machine-readable medium, wherein the instructions are configured to:
direct fuel to a plurality of combustors, wherein each combustor is coupled to a plurality of fuel nozzles positioned proximate to a first end of the combustor and at least one fuel injector positioned proximate to a second end of the combustor, the second end being downstream from the first end;
control a first valve to stop a first flow of fuel to a subset of the plurality of combustors; and
control a second valve to adjust the second flow of fuel to the at least one fuel injector of at least one of the plurality of combustors that is not part of the subset.

16. The system of claim 15, comprising a controller having the instructions.

17. The system of claim 15, comprising one or more sensors configured to detect a characteristic of a combustion process.

18. The system of claim 17, wherein the instructions are configured to control the first valve to stop the first flow of fuel to the subset and to adjust the second valve after the one or more sensors detects that a flow rate of the first flow of fuel to the subset is reduced to zero.

19. The system of claim 18, wherein the instructions are configured to stop the second flow of fuel to at least one fuel injector of at least one of the plurality of combustors that is not part of the subset.

20. The system of claim 15, wherein the instructions are configured to control the second valve to reduce the second flow of fuel to the at least one fuel injector of at least one of the plurality of combustors not in the subset after controlling the first valve to stop the first flow of fuel to the subset of the plurality of combustors.
